(19) United States
(12) Patent Application Publication
(10) Pub. No.: US 2021/0406512 A1
(43) Pub. Date: Dec. 30, 2021

(54) Method for assessing risk to marine hydrocarbon recovery operations

(71) Applicant: SHELL OIL COMPANY, Houston, TX (US)

(72) Inventors: David A. LAVALLEE, Houston, TX (US); Russell David POTTER, Houston, TX (US); Oliver MUELLENHOFF, Rijswijk (NL); Benjamin Thomas KING, Houston, TX (US); Stephen Edward KEEDWELL, Rijswijk (NL); Jason Dane MCCONOCHIE, Perth (AU); Paul Henry GARDNER, Rijswijk (NL)

(21) Appl. No.: 16/911,258

(22) Filed: Jun. 24, 2020

(51) Int. Cl. G06K 9/00; G01V 8/00; G06N 20/00; G06K 9/62

(52) U.S. Cl. CPC G06K 9/0063; G06K 9/6256; G06N 20/00; G01V 8/005

(57) ABSTRACT

A method for assessing risk to a marine hydrocarbon recovery operation involves collecting a set of training images and labeling sea surface anomalies on the set of training images. The set of training images and associated labels are used to train a model via backpropagation. A set of non-training images is collected and the trained model is applied to identify a potentially disruptive sea surface anomaly on the set of non-training images. Any risk to the marine hydrocarbon recovery operation by the potentially disruptive sea surface anomaly is then assessed.

### FIELD OF THE INVENTION

The present invention relates to the field of assessing risk to marine hydrocarbon recovery operations.

### BACKGROUND OF THE INVENTION

Hydrocarbon recovery operations in marine environments are subjected to potentially disruptive waves and currents. The disruptive waves or currents may cause detectable conditions on or near the sea surface that create anomalies that can be captured by remote imaging. However, there remains a need for a method to efficiently scan images to identify and locate the sea surface anomaly.

The sea surface around the globe is immense, as is the availability of satellite images, for example. Often, satellite images are reviewed for a targeted area to observe changes in the sea surface. But it is difficult to find sea surface anomalies over vast areas.

As discussed in Bao et al. (“Detection of ocean internal waves based on Faster R-CNN in SAR images” Journal of Oceanology and Limnology 38:1:55-63; 2020), internal waves can threaten the navigability of underwater submarines. Bao et al. acknowledge that manual interpretation of large amounts of remote sensing data is time-consuming and laborious. Accordingly, Bao et al. investigate an automated technology for accelerating processing of data to extract and identify target features from synthetic aperture radar (SAR) images of ocean internal waves using convolutional neural networks. Bao et al. produced an internal wave database for detecting internal wave stripes.

Wang et al. (“A fast internal wave detection method based on PCANet for ocean monitoring” J Intell Syst 28:1:103-113; 2019) relates to the detection of internal waves using unmanned aerial vehicles, because “it is impossible to repeatedly observe the same wave packet over a short period of time” using SAR images. Wang et al. use a PCANet for texture classification and object recognition.

Lavallee et al. (WO2020/086685A1) describe a backpropagation-enabled method for identifying a sea surface anomaly from satellite-acquired images and/or airborne images. An initial set of images is collected and sea surface anomalies in the image are labeled. The images and labels are used to train a model by backpropagation and the trained model can be used to identify a sea surface anomaly on a subsequent set of images.

There is a need for a method for assessing the risk to marine hydrocarbon recovery operations by improving the identification of a potentially disruptive sea-surface anomaly.

### SUMMARY OF THE INVENTION

According to one aspect of the present invention, there is provided a method for assessing risk to a marine hydrocarbon recovery operation, the method comprising the steps of: collecting a set of training images selected from the group consisting of satellite-acquired images, simulated satellite images, airborne-acquired images, simulated airborne-acquired images and combinations thereof; labeling a sea surface anomaly on the set of training images; using the set of training images and the labels to train a backpropagation-enabled process; collecting a set of non-training images selected from the group consisting of satellite-acquired, airborne-acquired images, and combinations thereof; applying the trained model to identify a potentially disruptive sea surface anomaly on the set of non-training images; and assessing risk to the marine hydrocarbon recovery operation by the potentially disruptive sea surface anomaly.

### BRIEF DESCRIPTION OF THE DRAWINGS

The present invention will be better understood by referring to the following detailed description of preferred embodiments and the drawings referenced therein, in which:

FIG. 1A illustrates one embodiment of a step of collecting a set of satellite training images for the method of the present invention;

FIG. 1B illustrates one embodiment of a step of collecting a set of simulated satellite training images for the method of the present invention;

FIGS. 2A-2D illustrate embodiments of a step of labeling a sea surface anomaly on a set of training images for the method of the present invention;

FIG. 3 illustrates one embodiment of a step of using a set of training images and associated labels to train via backpropagation for the method of the present invention;

FIG. 4A illustrates one embodiment of a step of collecting a set of non-training satellite images for the method of the present invention;

FIGS. 4B-4C illustrate further embodiments of a step of collecting a set of non-training airborne images for the method of the present invention; and

FIG. 5 illustrates one embodiment of a step of using the trained model to identify a sea surface anomaly in the method of the present invention.

### DETAILED DESCRIPTION OF THE INVENTION

The present invention provides a method for assessing risk to a marine hydrocarbon recovery operation so that appropriate measures can be undertaken in a timely manner to reduce the impact to the marine hydrocarbon recovery operation. A backpropagation-enabled process is trained with labels associated with a set of training images. Labels identify a sea surface anomaly from satellite-acquired images, airborne-acquired images and a combination thereof. The images are preferably acquired by synthetic aperture radar (S AR). The trained model is used to identify a potentially disruptive sea surface anomaly on a set of non-training images. Any risk associated with the potentially disruptive sea surface anomaly is assessed for its impact on the marine hydrocarbon recovery operation.

A sea surface anomaly is a deviation in the sea surface relative to the surrounding sea surface, including, for example, without limitation, surface expression of surface waves, internal waves, including solitons, currents, eddies, and the like. A potentially disruptive sea surface anomaly may be caused by a soliton, a tsunami, an earthquake, and combinations thereof.

Properties of the sea anomaly including wavelength, surface roughness, texture, speed, location, sea surface height, oscillation, frequency, and/or polarization can be used to identify the sea surface anomaly. In one embodiment, a potentially disruptive sea surface anomaly is identified in a first set of non-training images and changes in properties may be found by comparing one or more subsequent sets of non-training images to the first set of non-training images.

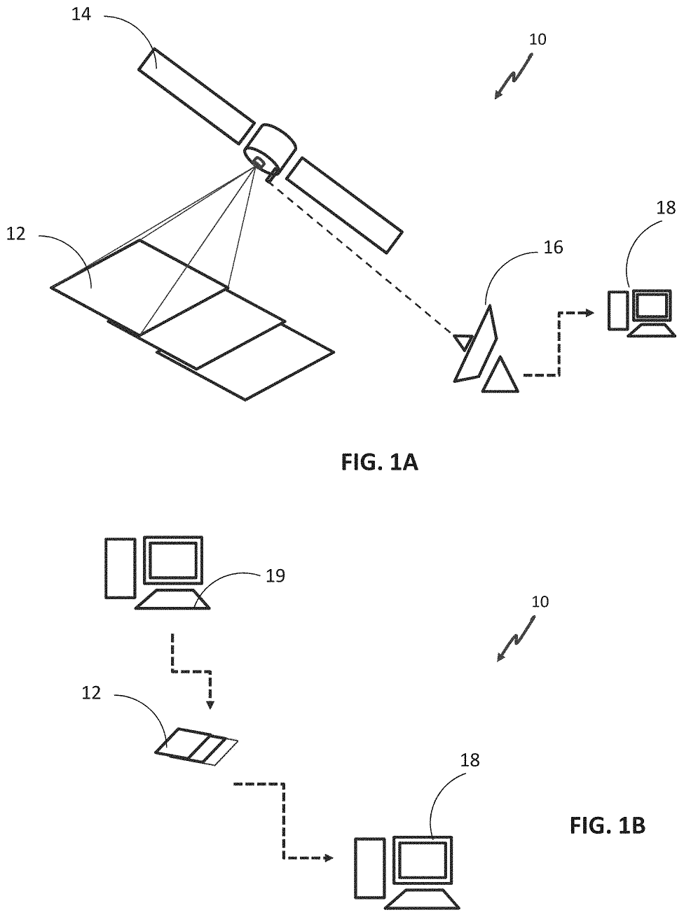

Referring now to FIG. 1A and FIG. 1B, as embodiments of a first step of the method of the present invention 10, a set of training images 12 are collected. The set of training images 12 may be satellite-acquired images, simulated satellite images, airborne-acquired images, simulated airborne-acquired images, and combinations thereof. Preferably, the non-training images are acquired by a SAR device associated with the satellite or airborne vehicle.

In the embodiment illustrated in FIG. 1A, the images are acquired from a satellite 14 and transmitted through a satellite receiver 16 to a processor 18, depicted generally in FIG. 1A by a desk-top computer. In the embodiment illustrated in FIG. 1B, the images are simulated satellite images produced by a computer 19 and transmitted to a processor 18, depicted generally in FIG. 1B by a desk-top computer. It will be understood by those skilled in the art that the processor 18 may take other forms than a desk-top computer. In a further embodiment, the simulated images may be produced at the same processor 18.

Sea surface anomalies in the set of training images 12 are labeled such that any pixel(s) defined to be part of a sea surface anomaly are identified. The sea surface anomalies may be labeled by a variety of techniques, including, but not limited to, segmentation, localization, classification, and combinations thereof. Segmentation may include generating a custom-polygon around a spatially contiguous sea surface anomaly and/or by labeling pixels.

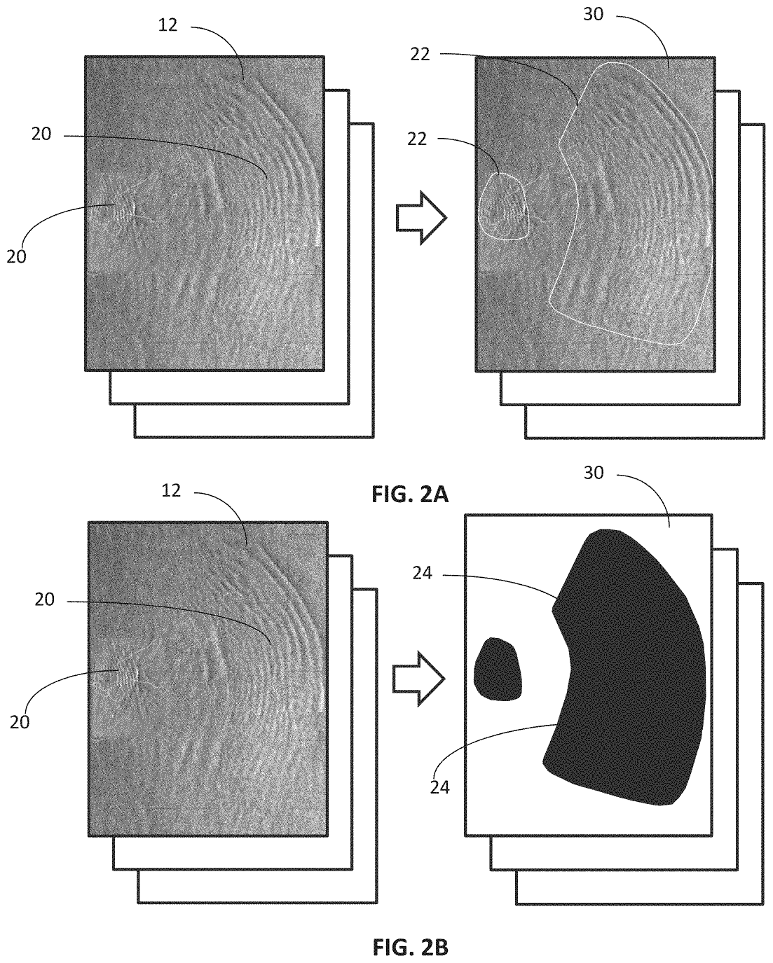

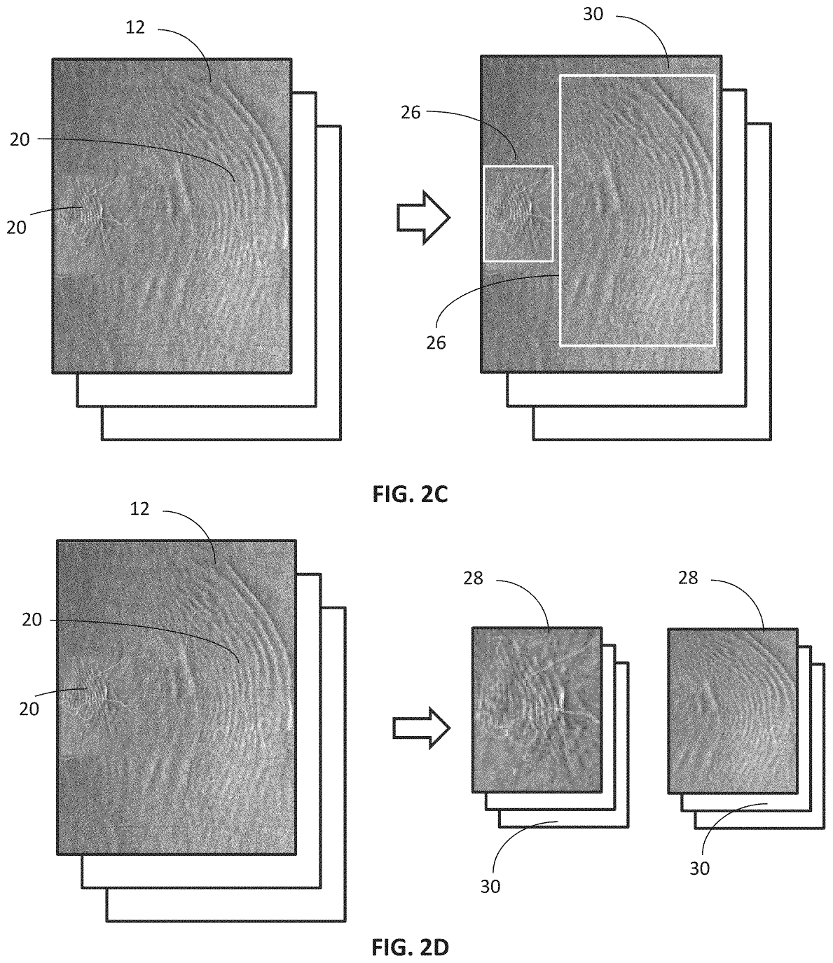

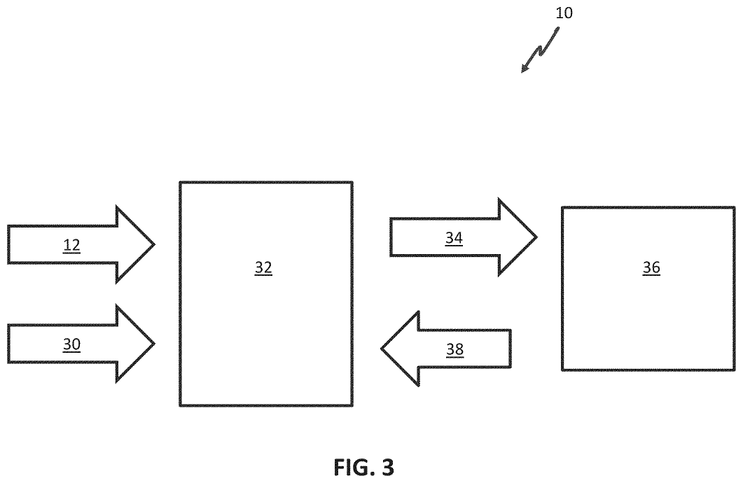

In the embodiment shown in FIG. 2A and 2B, sea surface anomalies 20 in a set of training images 12 are labeled by segmentation. In the embodiment of FIG. 2A, the label is a polygon image label 22 in a set of labels 30. In the embodiment of FIG. 2B, the label is an image mask label 24 in a set of labels 30. In another embodiment, the label may be generated by a localization technique to provide a box or other polygon around an entire sea surface anomaly. Box labels 26 in a set of labels 30 are illustrated in FIG. 2C. In the embodiment of FIG. 2D, the sea surface anomalies 20 are cropped and then classified with an image label 28 capturing the sea surface anomaly 20 in a set of labels 30. The cropped image may be further subjected to a segmentation technique, for example.

The set of labels 30 are used to train a model via backpropagation.

Examples of backpropagation-enabled processes include, without limitation, artificial intelligence, machine learning, and deep learning. It will be understood by those skilled in the art that advances in backpropagation-enabled processes continue rapidly. The method of the present invention is expected to be applicable to those advances even if under a different name. Accordingly, the method of the present invention is applicable to the further advances in backpropagation-enabled process, even if not expressly named herein.

A preferred embodiment of a backpropagation-enabled process is a deep learning process, including, but not limited to a convolutional neural network.

As depicted generally in FIG. 3, a preferred embodiment of the training step of the method of the present invention 10 inputs the set of training images 12 and corresponding set of labels 30 to an untrained algorithm, for example an untrained deep learning algorithm 32. The untrained deep learning algorithm 32 produces a prediction 34 for a sea surface anomaly and is compared in step 36 with the corresponding set of labels 30 from the set of training images 12. Model parameter adjustments 38 representing any error in the comparison are fed back to the algorithm 32 for updating.

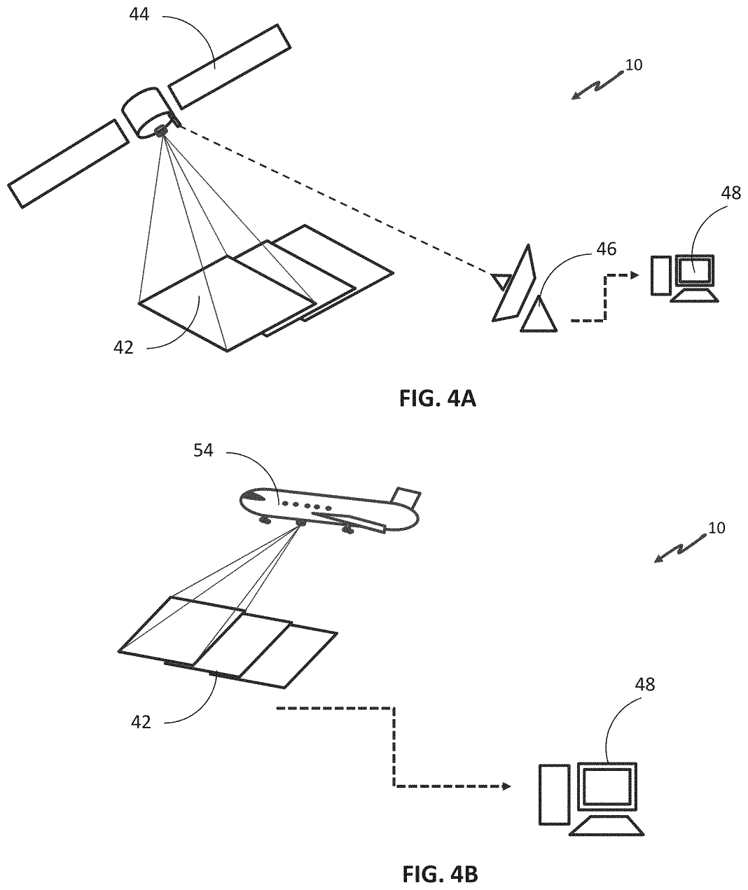

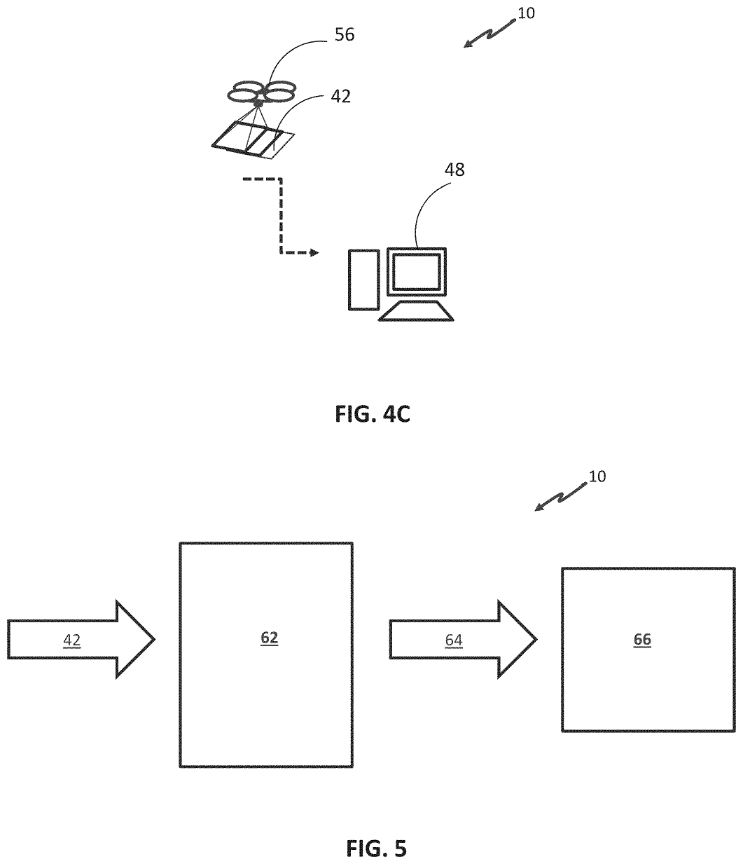

A set of non-training images 42, illustrated in FIGS. 4A-4C, is collected. The set of non-training images 42 is selected from the group consisting of satellite-acquired images, airborne-acquired images and combinations thereof. Preferably, the non-training images are acquired by a SAR device (not shown) associated with the satellite or airborne vehicle.

In one embodiment of the present invention, the set of non-training images 42 is acquired from a satellite 44 and transmitted through a satellite receiver 46. The satellite 44 and the satellite receiver 46 may each be the same as or different than the satellite 14 and the satellite receiver 46 used in the step of collecting an initial set of images (shown in FIG. 1A).

In another embodiment of the present invention, the set of non-training images 42 is airborne-acquired. Airborne-acquired images may be acquired using, for example, without limitation, an aircraft 54 (depicted in FIG. 4B) and/or a drone 56 (shown in FIG. 4C).

The set of non-training images 42 are transmitted to processor 48, depicted generally in FIGS. 4A-4C as a desktop computer. It will be understood by those skilled in the art that the processor 18 may take other forms than a desk-top computer. The processor 48 may be the same or different than the processor 18 illustrated in FIGS. 1A and 1B.

As illustrated in FIG. 5, the trained model 62 is applied to the set of non-training images 42. The trained model 62 produces a prediction 64 that is used to identify the sea surface anomaly in step 66. In accordance with the method of the present invention, the trained model 62 is used to identify a potentially disruptive sea surface anomaly in a set of non-training images 42. Any risk to any marine hydrocarbon recovery operations by the potentially disruptive sea surface anomaly can then be assessed.

In a preferred embodiment, the position coordinates are determined for the sea surface anomaly. Position coordinates include, for example, without limitation, a global coordinate reference system.

The method of the present invention is particularly suitable for assessing risk associated the potentially disruptive sea surface anomaly for the marine hydrocarbon recovery operation. Once a risk is predicted, the impact of the risk can be evaluated for the marine hydrocarbon recovery operation. Examples of marine hydrocarbon recovery operation risks include, without limitation, safety, leaks or produced fluids, leaks of chemicals used for hydrocarbon recovery, damage to subsurface equipment, damage to surface platforms, vessels and/or equipment, economic risks (for example, without limitation, by unnecessary shutdown), and combinations thereof.

While preferred embodiments of the present invention have been described, it should be understood that various changes, adaptations and modifications can be made therein within the scope of the invention(s) as claimed below.

What is claimed is:

1. A method for assessing risk to a marine hydrocarbon recovery operation, the method comprising the steps of:
collecting a set of training images selected from the group consisting of satellite-acquired images, simulated satellite images, airborne-acquired images, simulated airborne-acquired images and combinations thereof;
labeling a sea surface anomaly on the set of training images;
using the set of training images and the labels to train a backpropagation-enabled process;
collecting a set of non-training images selected from the group consisting of satellite-acquired, airborne-acquired images, and combinations thereof;
applying the trained model to identify a potentially disruptive sea surface anomaly on the set of non-training images; and
assessing risk to the marine hydrocarbon recovery operation by the potentially disruptive sea surface anomaly.

2. The method of claim 1, further comprising the step of determining the position coordinates of the sea surface anomaly.

3. The method of claim 2, wherein the position coordinates refer to a global coordinate reference system.

4. The method of claim 1, wherein the sea surface anomaly is selected from the group consisting of a surface expression of surface waves, internal waves, currents, eddies, and combinations thereof.

5. The method of claim 1, wherein the potentially disruptive sea surface anomaly is caused by a soliton, a tsunami, an earthquake, and combinations thereof.

6. The method of claim 1, wherein the training images are acquired by synthetic aperture radar.

7. The method of claim 1, wherein the non-training images are acquired by synthetic aperture radar.

8. The method of claim 1, wherein the potentially disruptive sea anomaly is detected by a property selected from the group consisting of wavelength, surface roughness, texture, speed, location, sea surface height, oscillation, frequency, polarization, and combinations thereof.

9. The method of claim 1, wherein the step of labeling is performed by a method selected from the group consisting of segmentation, localization, classification, and combinations thereof.

10. The method of claim 1, wherein the step of applying the trained model to a set of non-training images further comprises collecting a subsequent set of non-training images, and applying the trained model to identify changes in a property of the potentially disruptive sea anomaly.
